(19) United States
(12) Patent Application Publication
(10) Pub. No.: US 2020/0394930 A1
(43) Pub. Date: Dec. 17, 2020

(54) SYSTEMS, METHODS, AND APPARATUSES FOR IMPLEMENTING AN INDIVIDUALIZED EDUCATIONAL GROWTH PLATFORM WITH USER-AWARE FEEDS AND USER DIRECTED PROGRESSION

(71) Applicant: Arizona Board of Regents on Behalf of Arizona State University, Scottsdale, AZ (US)

(72) Inventors: Sasha Barab, Scottsdale, AZ (US); Walter Kalata, Scottsdale, AZ (US); Justin Messner, Phoenix, AZ (US); Anne Arici-Barab, Scottsdale, AZ (US); Zachary Ripka, Scottsdale, AZ (US)

(21) Appl. No.: 16/899,348

(22) Filed: Jun. 11, 2020

Related U.S. Application Data
(60) Provisional application No. 62/860,189, filed on Jun. 11, 2019.

(51) Int. Cl. G09B 5/12; G09B 5/02

(52) U.S. Cl. CPC G09B 5/12; G09B 5/02

(57) ABSTRACT

In accordance with embodiments disclosed herein, there are provided herein systems, methods, and apparatuses for implementing an individualized educational growth platform with user-aware feeds and user-directed progression. For example, there is disclosed a system having a memory to store instructions, a processor to execute the instructions stored within the memory, a database system communicably interfaced with the system to store educational content, and a student learner interface of the system, via which the system is to send and receive Graphical User Interface (GUI) interactions between the system and remote devices utilized by student learners. According to such an embodiment, the student learner interface of the system is to perform at least the following operations: connecting the student learner with people and ideas contextually relevant to the student learner; receiving selections from the student learner identifying growth opportunities of interest to the student learner, pushing contextually relevant educational content to the student learner based on the selections received from the student learner to permit the student learner to grow their skills and to inspire other student learners through the student learner interface of the system; receiving feedback from the student learner about peers and pushing feedback from the peers to the student learner to support community growth; and systemically tracking growth by the student learner in a subject matter area corresponding to the educational content to level up the expertise of the student learner. Other related embodiments are disclosed.

### CLAIM OF PRIORITY

This non-provisional U.S. Utility Patent Application is related to, and claims priority to, U.S. Provisional Patent Application No. 62/860,189, filed Jun. 11, 2019, entitled “SYSTEMS, METHODS, AND APPARATUSES FOR IMPLEMENTING AN INDIVIDUALIZED EDUCATIONAL GROWTH PLATFORM WITH USER-AWARE FEEDS AND USER DIRECTED PROGRESSION,” and having Attorney Docket No.: 37684.619P (M19-297P-PR1), the entire contents of which are incorporated by reference herein.

### GOVERNMENT RIGHTS AND GOVERNMENT AGENCY SUPPORT NOTICE

This invention was made with government support under 1433837 awarded by the National Science Foundation. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of educational content delivery, and more particularly, to systems, methods, and apparatuses for implementing an individualized educational growth platform with user-aware feeds and user directed progression.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Conventional educational platforms and learning management solutions focus first on content and second on the people and those learning about the content. Growth of the individuals, the motivations and interests of such individuals, and the community connections between those individuals are secondary to the content itself.

Consequently, the conventional approach for educational platforms treats content as being the most important asset, including more important than the people themselves. Such an approach fails to prioritize the individual interests of the people learning about the content or fully leverage the unique motivators to such individuals who may look to the educational content more as a tool to aid them in achieving their own individualized goals rather than merely an obstacle to be overcome.

There is needed an improved methodology and technological platform which reprioritizes people, their goals, interests, motivations, and connections above and beyond the content to be consumed while ensuring a systematic and well managed process through which such individuals may learn, grow, and advance their own progress through their chosen life journey.

Embodiments of the invention therefore improve upon prior known educational platforms and learning management solutions to leverage educational content as a tool and prioritize the needs of the individuals as paramount throughout their own individualized educational journey.

The present state of the art may therefore benefit from systems, methods, and apparatuses for implementing an individualized educational growth platform with user-aware feeds and user directed progression as are described herein.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1A depicts a mobile view of the educational growth platform, in accordance with described embodiments;

FIG. 1B depicts another mobile view of the educational growth platform, in accordance with described embodiments;

FIG. 1C depicts another mobile view of the educational growth platform, in accordance with described embodiments;

FIG. 1D depicts another mobile view of the educational growth platform, in accordance with described embodiments;

FIG. 1E depicts another mobile view of the educational growth platform, in accordance with described embodiments;

FIG. 2A depicts various the growth and impact cycle for users of the educational growth platform, in accordance with described embodiments;

FIG. 2B depicts further detail for the growth and impact cycle within the educational growth platform, in accordance with described embodiments;

FIG. 2C depicts collections within the educational growth platform, in accordance with described embodiments;

FIG. 2D depicts additional detail for collections within the educational growth platform, in accordance with described embodiments;

FIG. 3 depicts a user-aware feed within the educational growth platform, in accordance with described embodiments;

FIG. 4 depicts a group page, along with relevant data and alerts within the educational growth platform, in accordance with described embodiments;

FIG. 5A depicts a Micro-Certification Framework for user achievement within the educational growth platform, in accordance with described embodiments;

FIG. 5B depicts Micro-Certification progression for user achievement within the educational growth platform, in accordance with described embodiments;

FIG. 6 depicts details of the underlying platform technical infrastructure in support of the educational growth platform, in accordance with described embodiments;

FIG. 7A depicts an exemplary thrive integrations methodology for the educational growth platform, in accordance with described embodiments;

FIG. 7B depicts the partnership process of the educational growth platform, in accordance with described embodiments;

FIG. 7C depicts another view of the partnership process of the educational growth platform, in accordance with described embodiments;

FIG. 7D depicts another view of the partnership process of the educational growth platform, in accordance with described embodiments;

FIG. 8A depicts a facilitator toolkit for managing Micro-Certificate progress within the educational growth platform, in accordance with described embodiments;

FIG. 8B depicts a group invitation tool within the educational growth platform, in accordance with described embodiments;

FIG. 9A depicts a manager dashboard for managing groups within the educational growth platform, in accordance with described embodiments;

FIG. 9B depicts another manager dashboard for managing groups within the educational growth platform, in accordance with described embodiments;

FIGS. 9C and 9D depict a champion dashboard within the educational growth platform, in accordance with described embodiments;

FIG. 10A depicts a research optimization interface within the educational growth platform, in accordance with described embodiments;

FIGS. 10B and 10C depict another research optimization interface within the educational growth platform, in accordance with described embodiments;

FIG. 11 depicts a flow diagram illustrating a method for implementing an individualized educational growth platform with user-aware feeds and user directed progression, in accordance with the described embodiments;

FIG. 12 shows a diagrammatic representation of a system within which embodiments may operate, be installed, integrated, or configured, in accordance with one embodiment; and

FIG. 13 illustrates a diagrammatic representation of a machine in the exemplary form of a computer system, in accordance with one embodiment.

### DETAILED DESCRIPTION

Described herein are systems, methods, and apparatuses for implementing an individualized educational growth platform with user-aware feeds and user directed progression. For example, there is disclosed a system having a memory to store instructions, a processor to execute the instructions stored within the memory, a database system communicably interfaced with the system to store educational content, and a student learner interface of the system, via which the system is to send and receive Graphical User Interface (GUI) interactions between the system and remote devices utilized by student learners. According to such an embodiment, the student learner interface of the system is to perform at least the following operations: connecting the student learner with people and ideas contextually relevant to the student learner; receiving selections from the student learner identifying growth opportunities of interest to the student learner; pushing contextually relevant educational content to the student learner based on the selections received from the student learner to permit the student learner to grow their skills and to inspire other student learners through the student learner interface of the system; receiving feedback from the student learner about peers and pushing feedback from the peers to the student learner to support community growth; and systematically tracking growth by the student learner in a subject matter area corresponding to the educational content to level up the expertise of the student learner.

Described herein is a mobile-first, next generation educational growth platform designed to connect people to the ideas and community to achieve goals that matter to them supported by an engaged champion.

Through the ThriveCast Platform, players connect with opportunities they want to pursue and are then supported in their journey to grow their unique potential to thrive. According to certain embodiments, ThriveCast implements an educational growth platform which is available on desktop, or through the Apple and Google Play stores for phones and tablets, built using NodeJS and React Redux, and hosted on AWS using a ‘thin and light’ platform infrastructure with interoperable APIs and a user-aware feed.

Prior educational frameworks establish a pipeline model within which education is largely one of transmitting information from content creators to student learners, leaving many learners disengaged and struggling to find relevance to their personal goals.

Conversely, the educational growth platform which is described herein provides a model and user flow that positions possible outcomes as the primary driver (rather than memorizing and consuming content being the driver), with user choice in the particular learning pursuit depending on their goals with content and peers in a supporting role.

Such a model is better suited to focusing youth on developing STEM pathways and working with undergraduate students focused on career development, as it better accounts for the widely varying cultural and socioeconomic backgrounds that student learners originate from.

Moreover, by presenting a gamified learning and management system as part of the educational growth platform, experimental evidence shows that students find the content ultimately to be more engaging and in general, such students felt that prior models were much more focused on the content rather than how such content might apply to their own lives, including their goals and aspirations.

Responsive to the desire for student learners to re-focus the educational experience on their own lives, the “Thrive” concept was developed, prioritizing value creation over content consumption and by further adding an apply phase and a grow phase for such student learners.

The Thrive concept is thus focused on helping people understand why they are learning before engaging in what were the content specifics they could leverage as tools to realize their “why.” This concept thus drives the importance of connecting with life examples of particular interest to the student learners before asking those student learners to memorize and consume content, with additional support from a “connect” phase which is described in greater detail below.

Later iterations brought forth a number of life application stories to make the content more relevant to the student learners. It was then observed that student learners were far more motivated by peer stories than any developed directly by the content creators.

Therefore, a peer connection construct was created supported by adding peer stories in the connect phase, along with group identity constructs supported by adding groups to educational growth platform.

Various platform methodologies were then integrated via the educational growth platform with so called “jobs-to-be-done” which were tracked and managed via a thin-and-light design embodied by the educational growth platform described herein.

Furthermore, the design and the role of the group champion is incorporated into the educational growth platform to support members (e.g., student learners) in their individualized growth journey. It was through this process that a suite of tools was then designed to support facilitators in creating and managing groups, for instance, via the Facilitator Toolkit which is described below.

Due to the cost of working with certain champions, who likely know their own content better than facilitators of the educational growth platform, a suite of tools was created which permits anybody to design and iterate content via growth invitations (provided to student learners and facilitators via modules, collections, etc.), all of which is accessible through the educational growth platform.

A further concept of micro-certifications is built into the educational growth platform which are bounded growth opportunities driven by user-identified goals so as to be directly tied to a particular student learner's journey, and yet, remain tied to particular content area thresholds.

With the addition of micro-certifications (e.g., adding Micro-Certificates to the educational growth platform), a further construct of user-modes was introduced so as to leverage the fact that people are driven by personal and social interest. On this basis, a user-aware feed as was integrated as a primary landing page for the student learners supplemented by adding a user-curated feed each time the student learners enter the educational growth platform.

Collectively, it is these features which together provide realization of the ThriveCast innovation and educational growth platform which is detailed here, specifically focusing on people creating value in areas that are important to them, supported by peer stories and support, with a user-aware feed that connects them to the people and ideas relevant to their group activity as a whole; all of which is supported by an engaged champion having access to data reporting tools via the educational growth platform so as to support their respective users and iterate designs to improve effectiveness.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a specialized and special-purpose processor having been programmed with the instructions to perform the operations described herein. Alternatively, the operations may be performed by a combination of hardware and software. In such a way, the embodiments of the invention provide a technical solution to a technical problem.

Embodiments also relate to an apparatus for performing the operations disclosed herein. This apparatus may be specially constructed for the required purposes, or it may be a special purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various customizable and special purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.), a machine (e.g., computer) readable transmission medium (electrical, optical, acoustical), Radio-frequency identification (RFID) chips or tags, etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

In addition to various hardware components depicted in the figures and described herein, embodiments further include various operations which are described below. The operations described in accordance with such embodiments may be performed by hardware components or may be embodied in machine-executable instructions, which may be used to cause a special-purpose processor programmed with the instructions to perform the operations. Alternatively, the operations may be performed by a combination of hardware and software, including software instructions that perform the operations described herein via memory and one or more processors of a computing platform.

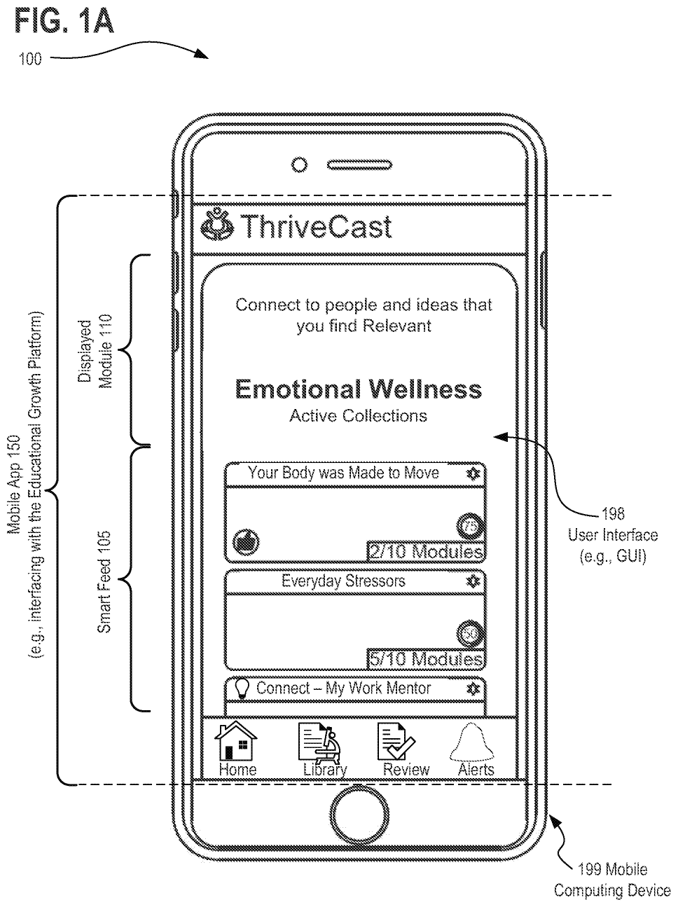

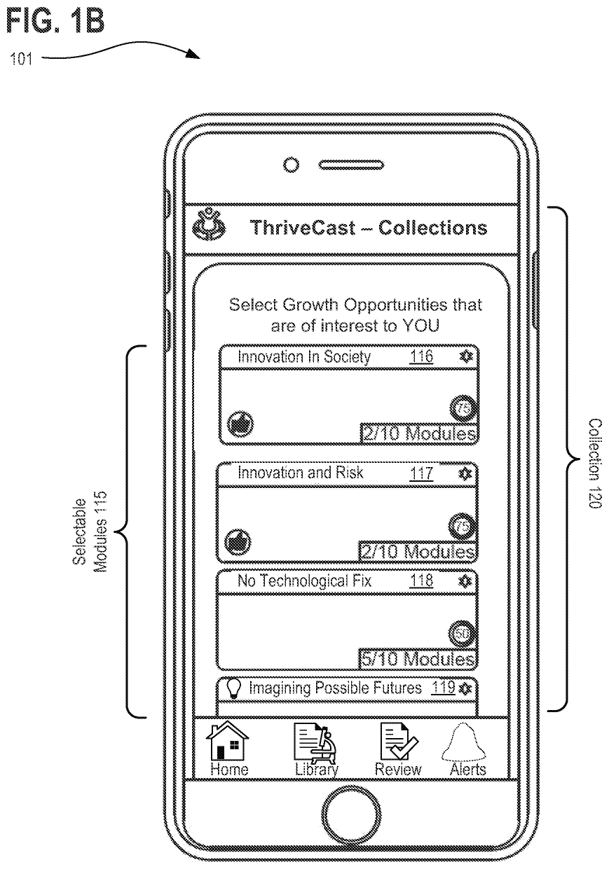

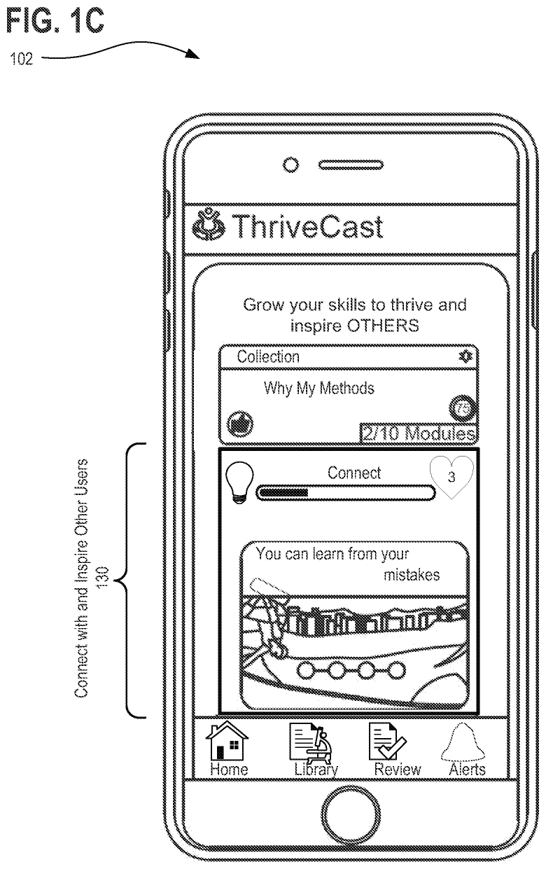

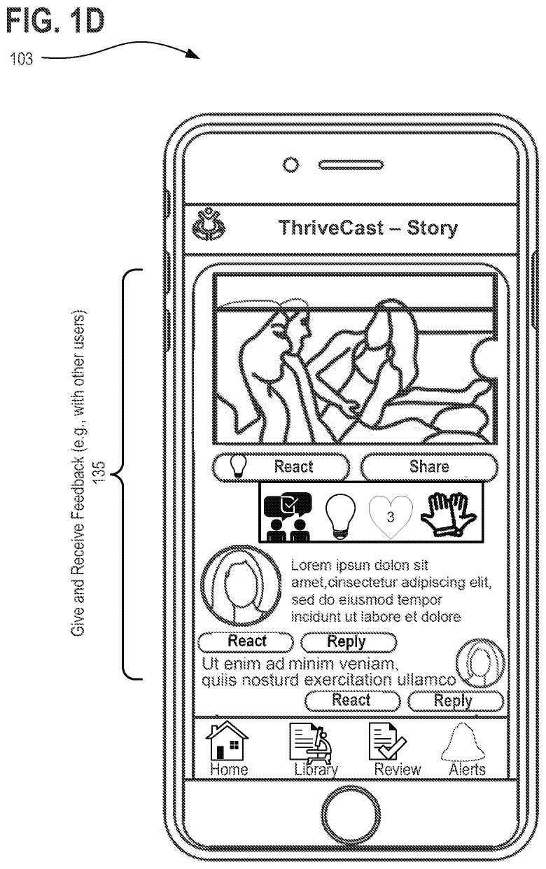

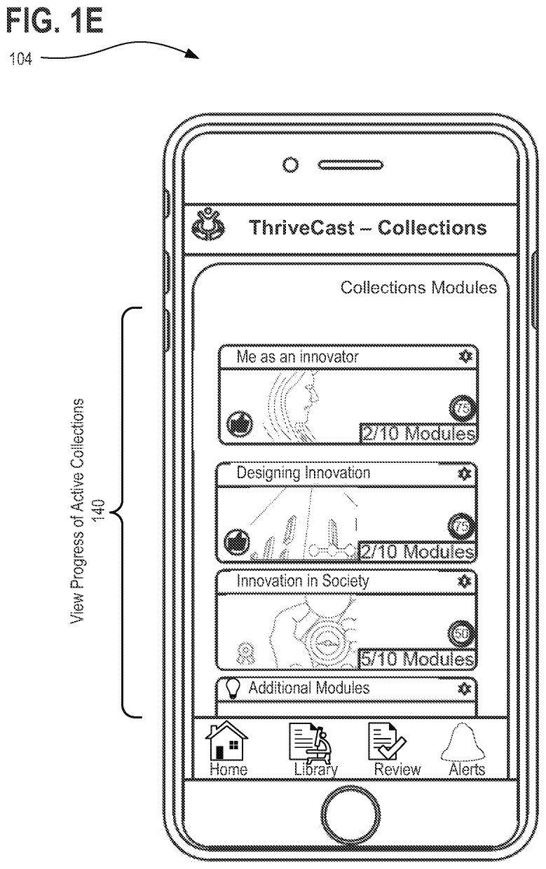

FIG. 1A depicts a mobile view 100 of the educational growth platform, in accordance with described embodiments.

As depicted, the educational growth platform permits users to access a smart feed 105 displayed to the user interface (e.g., GUI) 198 of the mobile computing device 199, through which such users may connect with people and ideas they find relevant. For instance, a user in this particular example may connect with other individuals or concepts related to emotional wellness by interacting with the displayed module 110 for “emotional wellness” displayed to the user interface 198 of the mobile computing device. For example, such a user may explore concepts, such as, how a body is made to move, everyday stressors, etc. Alternatively, the user may connect with their mentor through this mobile view of the educational growth platform, for instance, delivered to the mobile computing device 199 via the mobile app 150 executing on the mobile computing device 199.

FIG. 1B depicts another mobile view 101 of the educational growth platform, in accordance with described embodiments.

As shown here, the educational growth platform permits users to select growth opportunities of interest, each being a selectable module 115 from the user's smart feed as displayed to the GUI of the mobile computing device. For example, the user here may select various aspects of innovation in society 116, such as technology and society, imagining possible futures 119, innovation and risk 117, ecosystem integration, the “No Technological Fix” 118 selectable module 115, etc.

With regard to the content itself, ecosystem integration within the educational growth platform starts with conducting interviews to uncover the desired progress/jobs in a particular area.

When conducting an interview, one is not simply identifying occasions where people made progress in a particular area, but also identifying resources they hired to make progress. For example, when learning about how to create a resume, it was observed that many interviewees hired friends, created websites, or leveraged example websites hosted on job sites.

The ThriveCast model therefore supports multiple unique collections 120 of growth opportunities focused on diverse content areas, such as personal wellness, innovator's journey, career exploration, digital literacies, etc., with each one having numerous growth selectable modules 115.

For example, an “Architecting My Futures” offering provides multiple growth modules identified as relevant to supporting undergraduate growth in career development.

Building the growth opportunities involves using the “Thrive Integrations Methodology,” which includes the process for building, implementing, and optimizing partnerships.

This process involves multiple activities, including for example, Journey Mapping, which is the process of identifying/validating goals that members of your community want to achieve, uncovering struggles and success stories to ensure that designs are likely to be viewed as useful.

Content development is therefore grounded in an understanding of what users want to get done, with the next stage involving digitizing and ‘thrivifing’ existing and newly identified resources to create growth opportunities that members are likely to engage and be useful in achieving valued goals.

FIG. 1C depicts another mobile view 102 of the educational growth platform, in accordance with described embodiments.

As shown here, the educational growth platform permits users to grow and develop their skills to thrive and inspire others. For example, the user may explore their methods, connect with, and inspire other users 130 as well as learning from their own mistakes and the mistakes of others.

FIG. 1D depicts another mobile view 103 of the educational growth platform, in accordance with described embodiments.

As shown here, the educational growth platform permits users to select give and receive feedback 135 to support community growth. For example, the user here may interact with other users on the educational growth platform, including commenting, sharing, and providing various reactions. Similarly, other users may then comment and interact with the comments, reactions, and other interactions of the original poster/commenter.

FIG. 1E depicts another mobile view 104 of the educational growth platform, in accordance with described embodiments.

As shown here, the educational growth platform permits users to complete micro-certificates based on reaching critical thresholds related to scores on connect, grow, apply, and inspire accomplishments. For example, the user here may view their progress towards various objectives for any active collection 140 in an effort to gain a micro-certification for such a collection. For example, progress may be measured through various goals, such as attaining points and completing modules that particular user is working toward as an “innovator” or by completing modules within the collection such as “designing innovation” or “innovation in society,” etc.

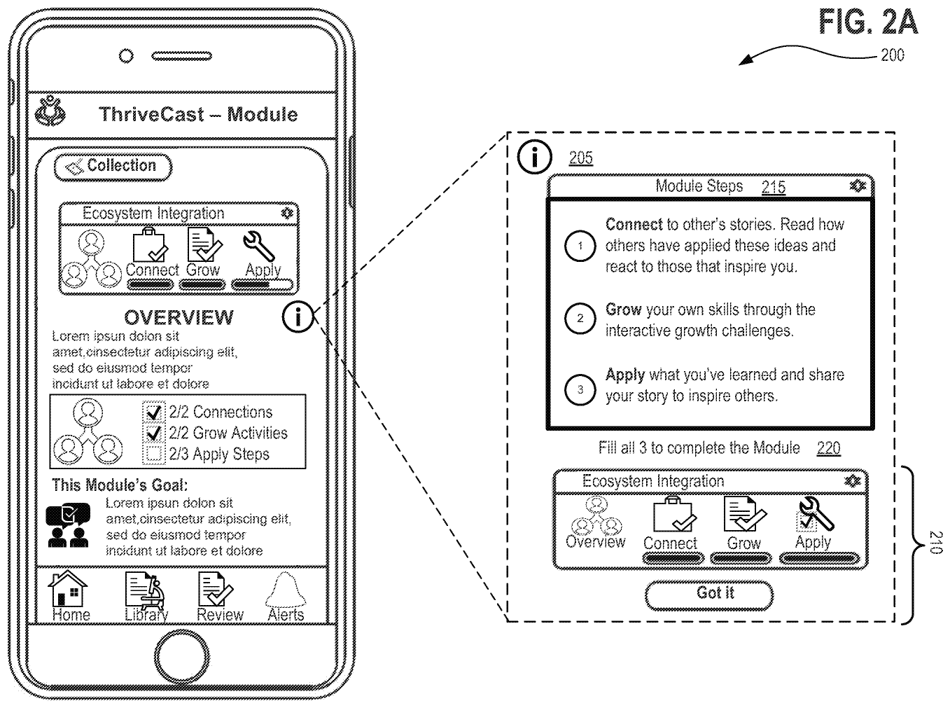

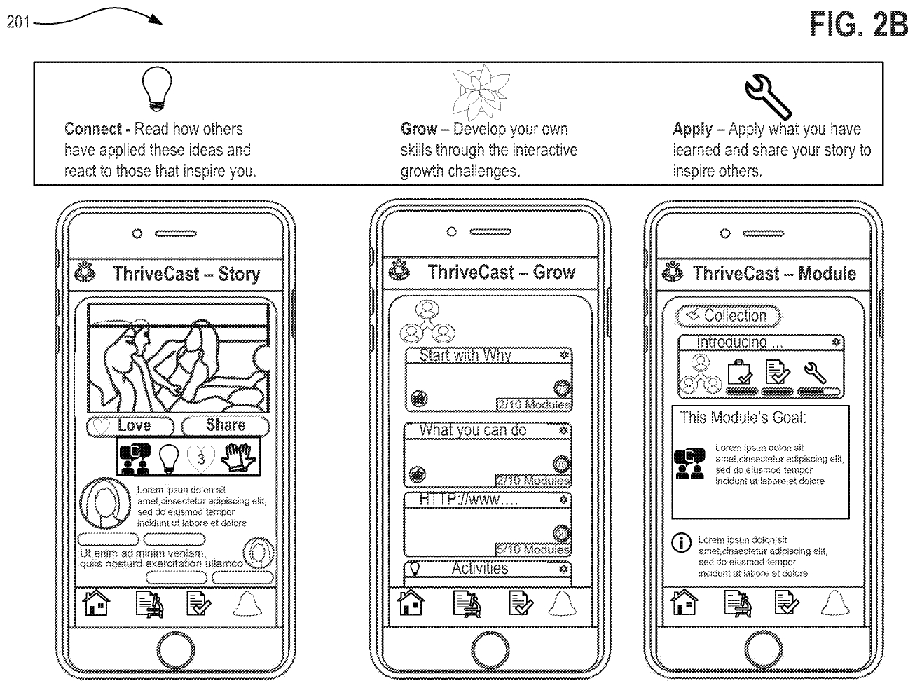

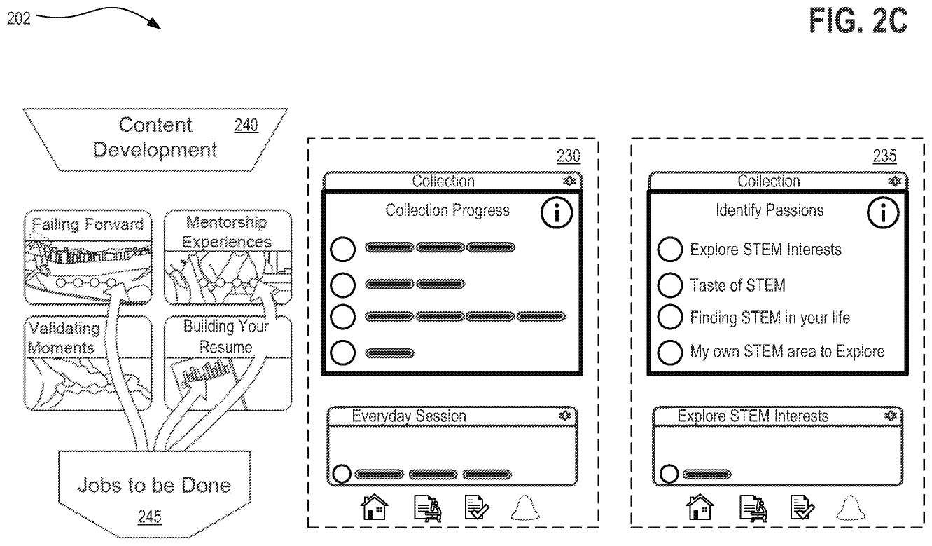

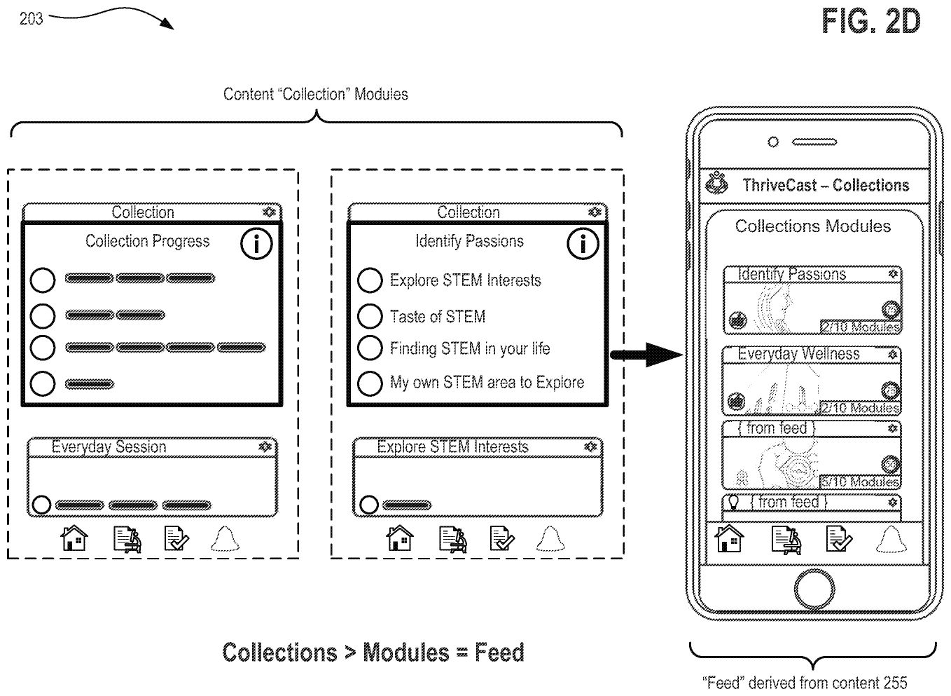

FIG. 2A depicts various the growth and impact cycle 200 for users of the educational growth platform, in accordance with described embodiments.

As shown here, there are multiple core phases of a module, including the mobile overview 205 where a user gets information about the module goal and overall progress 210.

For example, via the overview 205 screen for the “ecosystem integration” collection, the user is presented with an abstract statement about the module followed by progress 210 towards various objectives including “connections” and “grow activities” and application of “steps,” followed by a statement regarding that particular module's goal.

As shown here, each depicted module has three distinct steps 215, including connect, grow, and apply. Connect permits the users to connect with others' stories, reading about how others have applied the ideas and permitting the user to react to those that inspire them. Grow permits the user to grow their own skills through the interactive growth challenges provided via the educational growth platform. The “apply” phase permits the user to apply what they have learned and to further share their story in order to inspire others. In a game like fashion, the user must earn points through interacting with the educational growth platform so as to fill all three steps in order to complete 220 the module in question.

Ecosystem integration leverages designed invitations to thrive, in which the educational growth platform works with student learners to identify process integration strategies to ensure members engage these opportunities in ways that are engaging and can be sustained at scale.

FIG. 2B depicts further detail for the growth and impact cycle 201 within the educational growth platform, in accordance with described embodiments.

As shown here, a user may obtain information about the module goal and overall progress including taking further actions such as connecting with peer application stories to become inspired (depicted on the far left), observing activity pertaining to the user's growth for specific content related achievements within and outside ThriveCast that are published to the Learning Record Store (depicted at center) and interact with application stories that meet key module criteria which may then be either accepted or rejected by the user's peers and/or group facilitators (depicted at far right).

FIG. 2C depicts collections 202 within the educational growth platform, in accordance with described embodiments.

As shown here, there exist various collections 230 and 235 available to the student learners which are reachable through user directed paths rather than being dictated by a specific learning pipeline. The collections are derived from the results of content development 240 which result in various jobs to be done 245 by the student or learner, such as the “failing forward,” “mentorship experiences,” “validating moments” and “building your resume” as depicted here.

FIG. 2D depicts additional detail for collections 203 within the educational growth platform, in accordance with described embodiments.

As shown here, the collections are greater than merely the modules as they represent the student learner's interactions with the modules and the user-aware feed.

Thus, when a learner starts on a journey, that learner should do so because the outcomes matter to them specifically. The educational growth platform thus enables the idea that journeys should be driven by the learner, queued by personal or social relevance, and not any content designer's dictated funnel, thus permitting the user to receive the smart feed as derived from previously curated content 255, based on that particular user's navigation through their journey.

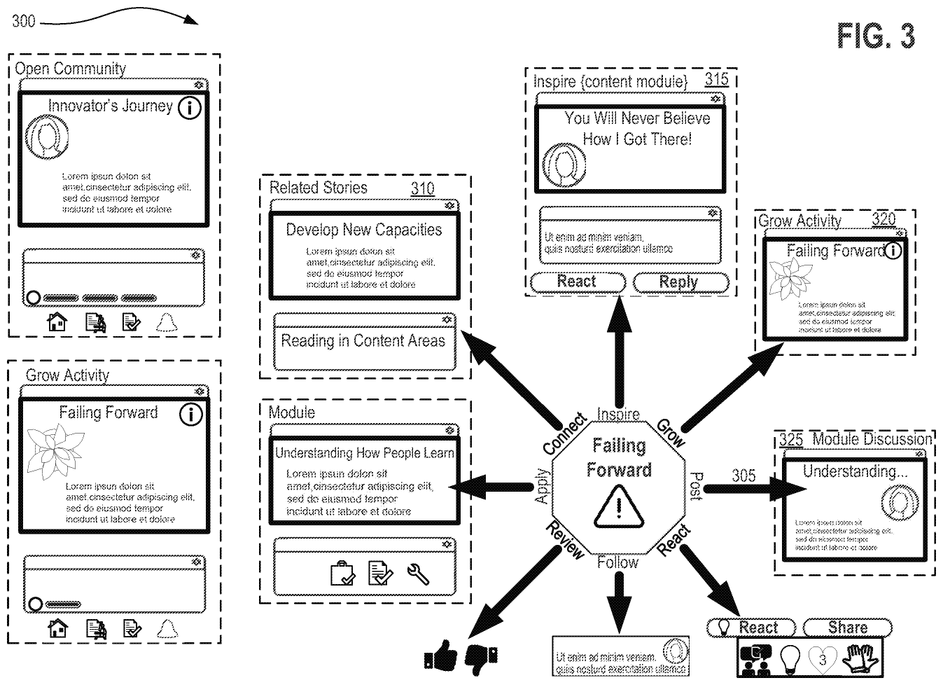

FIG. 3 depicts a user-aware feed 300 within the educational growth platform, in accordance with described embodiments.

As shown here, the user-aware feed 300 of the educational growth platform, is provided to the user along with different available modes of interaction. Such modes of interaction include clickable feed cards based on previous user achievements as well as their peers so as to ‘recommend’ next growth areas, privileging personal and peer interests to suggest next cards via the user-aware feed.

As users scroll within the field they may conduct interactions with the Graphical User Interface (GUI) generated by the educational growth platform such as (a) passing on a suggested card, (b) clicking to read more about card content, (c) interacting with the card based on mode type, or (d) clicking through to work on the related module. For instance, depicted here are several suggested cards exposing modules such as the “related stories” card 310 and card 315 via which the student learner may “inspire” others. Further depicted are the grow activity 320 card and the module discussion 325 card.

Furthers still, because one user can publish or post 305 their accepted work to inspire another user, a network effect is created which thus in turn increases the social relevance to both parties.

In such a way, community-produced stories inspire choice as opposed to participation simply being driven by a designed “channel” from which student learners are directed to consume and absorb content. In contrast to a consumption-focused learning system, the educational growth platform is based on an invite, enable, and release framework with an emphasis on value-creation of learners which thus begins with understanding the relevant progress and value-creation occasions that successful members make.

Stated differently, rather than the educational growth platform focusing on the yet to-be-learned content that educators and facilitators want people to know, the emphasis by the educational growth platform is instead on what progress people want to make, such as, the “job to be done” by that student learner after growing and learning about the necessary educational content which will enable them to perform such a job.

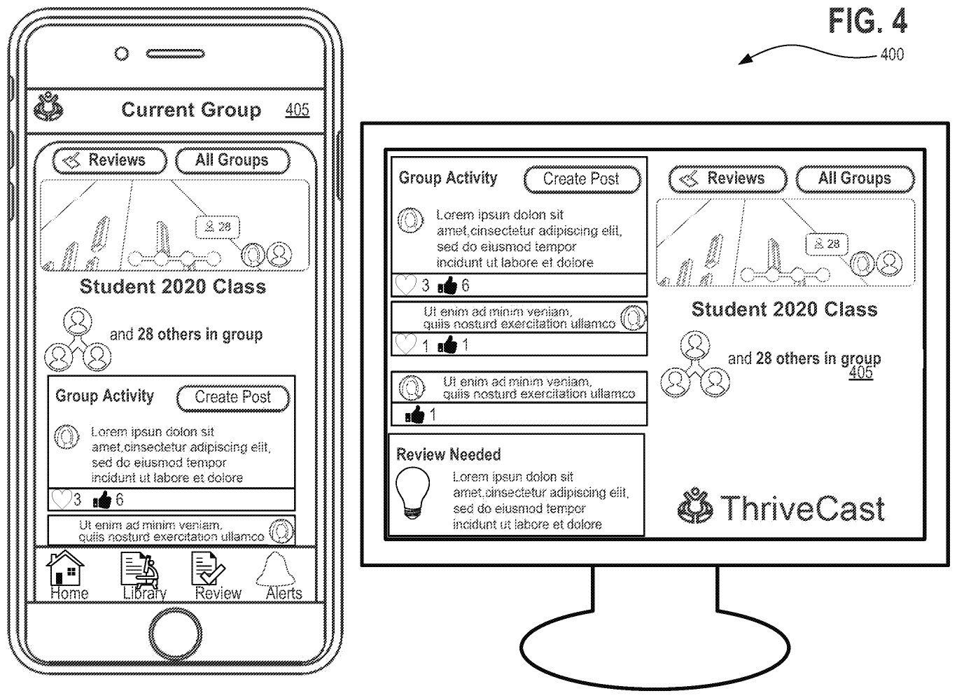

FIG. 4 depicts a group page 400, along with relevant data and alerts within the educational growth platform, in accordance with described embodiments.

As shown here, the group page, along with relevant data and alerts within the educational growth platform, permits users to create “gamified” feedback along with data regarding community interactions so that social relevance can guide peer choice.

Facilitators, or even other users, may further recruit other users into a particular group 405, having specific people through which they are on the journey to make progress in the particular content associated with that group.

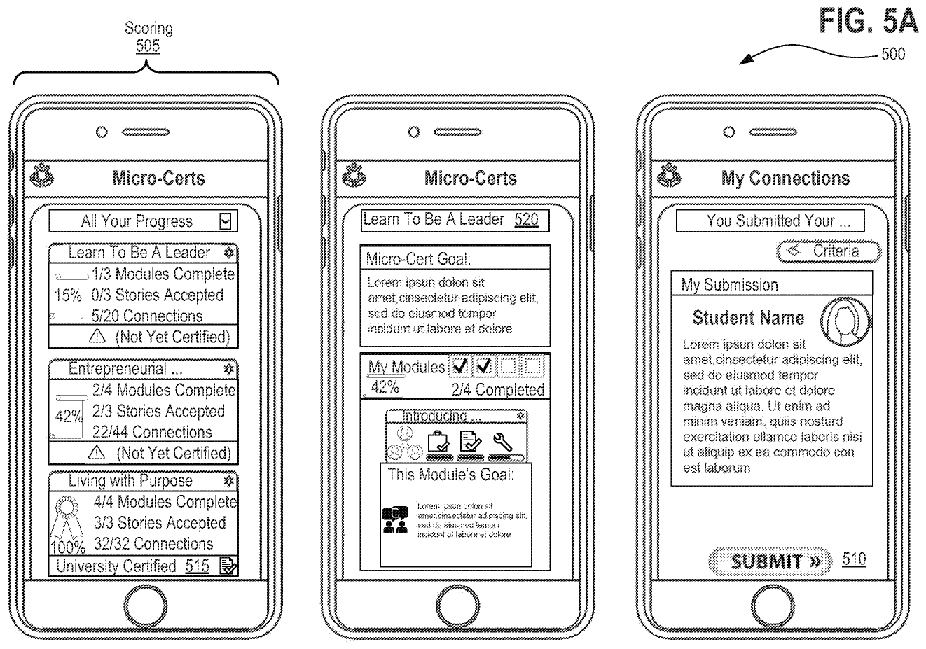

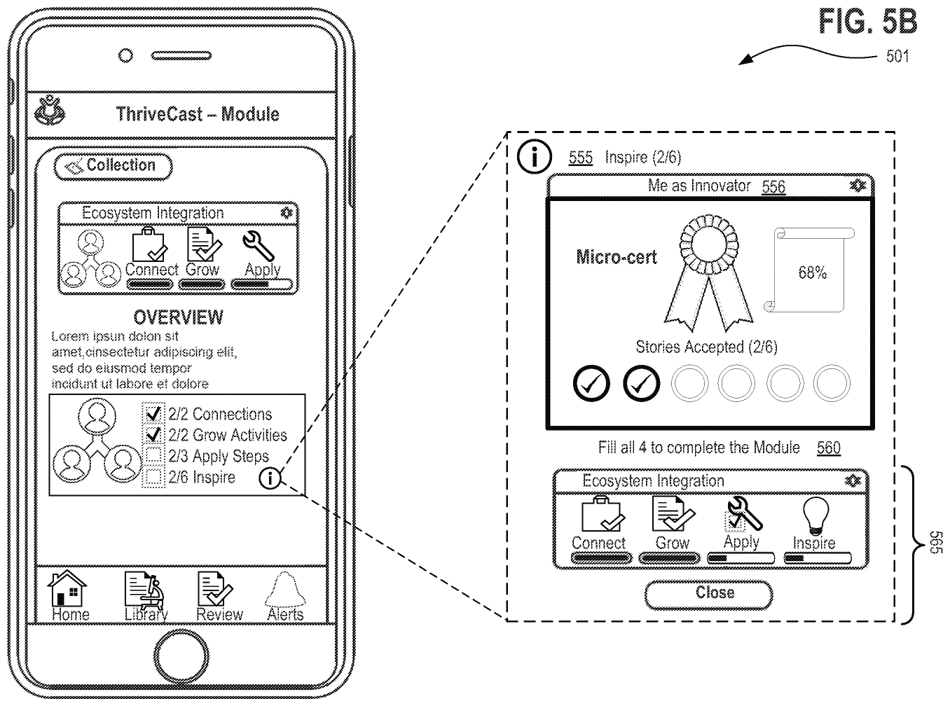

FIG. 5A depicts a Micro-Certification Framework 500 for user achievement within the educational growth platform, in accordance with described embodiments.

As shown here, a Micro-Certification Framework is provided via the educational growth platform to track and measure user achievement. Such user achievement is attained through user-created journeys that are built in relation to designer-recommended modules, and include particular thresholds on module and story counts, along with threshold scores 505 related to connect points and inspire points with the latter inspire points including reviews and feedback to other peers along with counts of other members that have connected or comment on the individual's published stories 510.

These Micro-Certificates are initially certified by the local group facilitator, but then can be resubmitted for review by accredited endorsement entities as well.

For example, a high school student may gain high-school credit through their local group facilitator for the high school, but then re-submit their work for consideration by a university which may then review the work and consider whether or not the work is sufficient to attain dual enrollment credit with both the high school and also the university, thus granting university certification 515 (e.g., university credit).

As depicted here, the user has attained partial progress toward “learning to be a leader,” 520 in which only one of the modules are complete, none of the stories have been accepted, and five of the twenty required “connections” have been made. Consequently, the micro-cert has not yet been attained. Conversely, the “living with purpose” module has been satisfied and certified by the group leader, with 4/4 modules having been completed, 3/3 stories accepted, and 32/32 connections having been made. In the center left screen, the “entrepreneurial mindset” is partially complete but not yet certified.

In the center view, the “entrepreneurial mindset” module may be observed in additional detail, in which there are various components indicated as “required”, others complete, and yet other interaction opportunities for the user's stories.

On the right most view, the user may submit 510 their “reflections” in support of the particular micro-cert being sought.

Notably, the student learners are sometimes referred to as “players” rather than students or users. At its core, one focus of the educational growth platform is to engage players in value creation, first by connecting such players to peer stories and then by growing relevant skills of the “players” such that student learners may apply what they are learning and ultimately to create their own real-world story that meets the key module focus.

Players and student learners next share their reflection of the experience as a thrive story, which is first engaged by others through a process of peer review and feedback. If two or more users accept the work as addressing the application criteria then the author has the opportunity to make their story public, becoming available to inspire others as they engage the Connect stage.

Such a user-flow is consistent with other discussions on the value of connected learning and is consistent with the educational growth platform methodology in which a key value exchange is what members create and contribute as opposed to only what the design team creates.

For instance, it has been observed that once a student learner or “player” engages an invite-enable-release methodology with the goal of supporting co-created value, then it is essential to cultivate community connection in which one member's “release” provides an invitation and/or grow for another member.

With a commitment to connected growth, an important design principle of the educational growth platform is to permit users to go beyond creating value for themselves and actively contribute back to the community, engaging other users' ideas and continuing the conversations.

Further still, in addition to a student learner or “player” completing the modules via the educational growth platform, members have the opportunity to support the growth of others by reviewing submitted stories, commenting on published stories, and making one's accepted story available to others for connecting; thereby, cultivating a living ecosystem that gains value over time as more people share their value-creation experiences.

It is therefore in accordance with particular embodiments that a user-aware feed pulls from various data stores operating within the educational growth platform or connected with the educational growth platform for all available modules to identify stories that might be of interest, relevant growth opportunities, or entire modules that are relevant based on current user progress.

FIG. 5B depicts Micro-Certification progression 501 for user achievement within the educational growth platform, in accordance with described embodiments. In particular, it is further shown within the user's mobile view that a fourth learning engagement phase is provided, specifically, “inspire,” thus, providing the full path of connect, grow, apply, and then inspire.

In the expanded mobile “inspire” view 555 on the right hand side, it is further displayed to the student learner's GUI interface a “me as innovator” 556 screen, within which the user may view progression toward a micro-certification. In this particular depiction, the user has attained 68% progression, at least a portion of which is attributable to points and XP (experience points) associated with inspiring others, measured by how many stories that particular user or student learner has had accepted. As shown here, the user has had two (2) of the requisite six (6) stories accepted. All four modules (e.g., connect, grow, apply, and inspire on the navigation pane 565) must be fully completed to attain 100% completion and thus earn the micro-certification, as denoted by element 560.

A student learner earns points for “apply” by writing and sharing their story with others via the educational growth platform. This shared story is then added into the content queue and made accessible to other student learners. Consequently, that first user's story may be surfaced, recommended, or explored by a second user. When that second user connects with the first user's story, the first user (having shared the story) then gains “inspire” points, while the second user that connected with the story gains “connect” points.

In such a way, points and XP toward the inspire portion of the micro-certification may be gained by contributing user created content to the educational growth platform which thus provides for organic growth internal to the educational growth platform which ultimately supplements the designer created content and administrator curated content (e.g., licensed third party content, etc.) available to student learners via the educational growth platform.

Stated differently, each student learner or user becomes not just a consumer of content on the educational growth platform but also a producer of original content to the educational growth platform which contributes to the network effect for the educational growth platform, thus increasing both the amount of available content and also the value of the educational growth platform itself, to student learners engaged with the platform.

According to a particular embodiment, inspire points are allocated to a student learner having contributed a story when one or more other student learners “reply” or “react” to the story or alternatively when a threshold number of other student learners reply or react to the story.

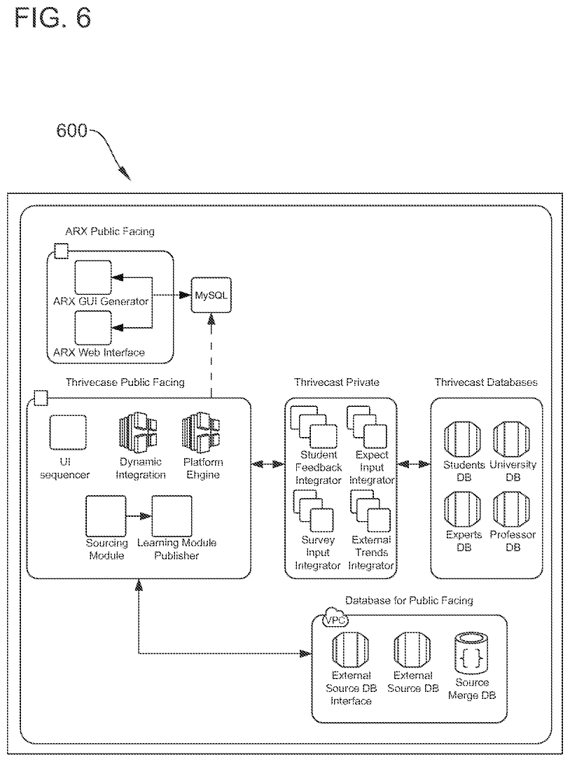

FIG. 6 depicts details of the underlying platform 600 technical infrastructure in support of the educational growth platform, in accordance with described embodiments.

As shown here, the underlying platform technical infrastructure is designed via a React front end which communicates using GraphQL to more than a dozen thin and light gRPC micro-services via a public internet facing framework manager which acts as part firewall, session manager, and broker.

The micro-services as well as the framework manager are authored in Node.JS, however other coding platforms and communication frameworks may be utilized other than that which is depicted here.

As may be observed from FIG. 6, there is an ARX public facing module having multiple instances, each being in communication with a MySQL server. The MySQL server interacts with a ThriveCast public facing module and public facing databases as well as a ThriveCast private module, and multiple private ThriveCast databases. According to the embodiment depicted here, the infrastructure may be hosted by a cloud computing platform, such as AWS.

According to one embodiment, a server cluster in AWS implements the MySQL databases with different micro-services, each having with their own role specific databases for various functions, such as curriculum, stories, progress, etc., along with a gRPC connection layer wrapped with NODEjs.

The gRPC connection layer (implementing so called Google Remote Procedure Calls”) is an open source remote procedure call (RPC) system initially developed at Google and which utilizes HTTP/2 for transport, Protocol Buffers as the interface description language, and provides features such as authentication, bidirectional streaming and flow control, blocking or nonblocking bindings, and cancellation and timeouts. The gRPC connection layer generates cross-platform client and server bindings for many languages. Most common usage scenarios include connecting services in microservices style architecture and connect mobile devices, browser clients to backend services.

According to a particular embodiment, the ThriveCast educational growth platform is designed as a “thin and light,” platform with a microservice patterned back end which offers high concurrency and tiered deep integration possibilities. The front-end is a responsive react product, and for progress, in addition to its own micro-services, utilizes Learning Locker as a Record Store so that others can subscribe using the xAPI protocol broadly adopted ADL xAPI Learning Record Store specification.

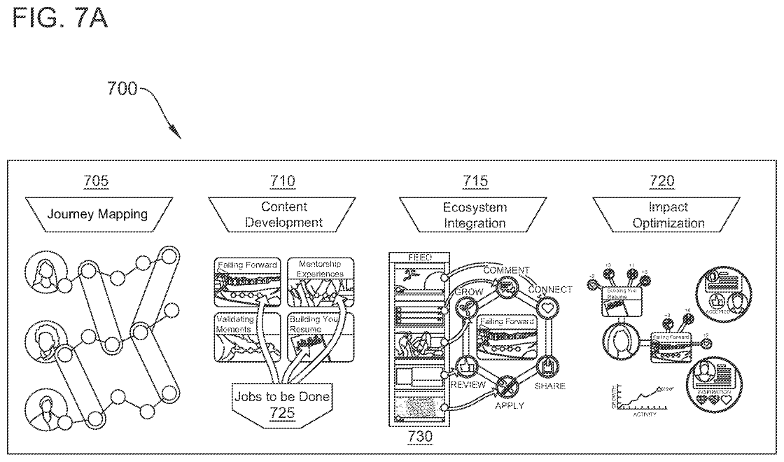

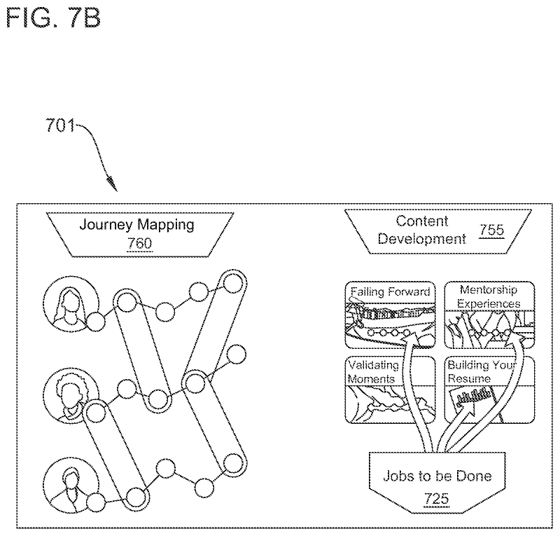

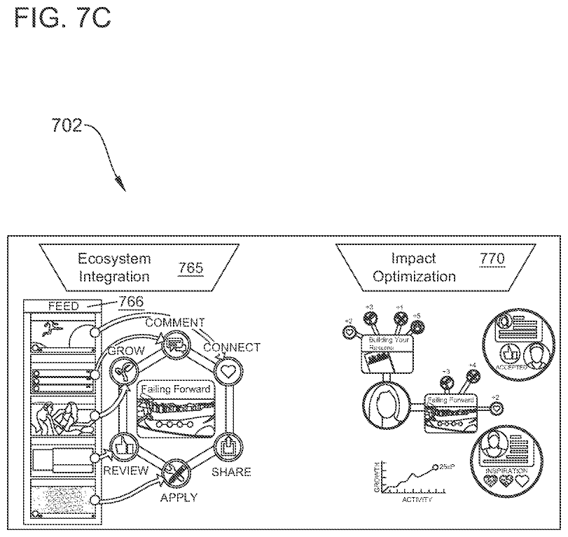

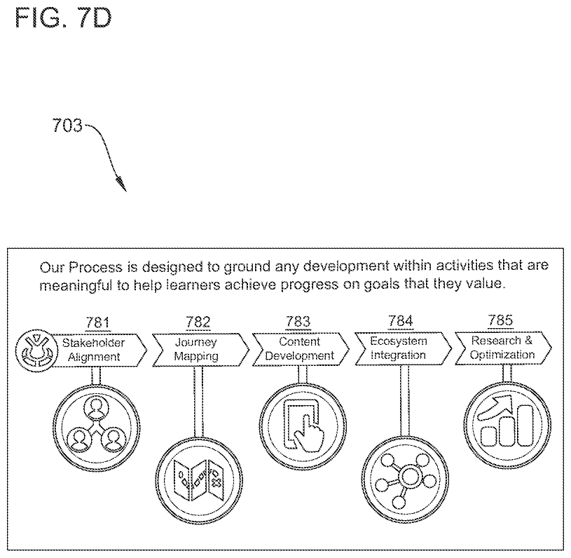

FIG. 7A depicts an exemplary thrive integrations methodology 700 for the educational growth platform, in accordance with described embodiments.

As shown here, the thrive integrations methodology 700 may include various phases including journey mapping 705, content development 710, ecosystem integration 715 within which the user is exposed to comment, connect, share, apply, review, and grow sub-operations, and finally impact optimization 720, each of which is facilitated via the educational growth platform.

In such a way, the thrive integrations methodology facilitates the user's progress by providing processes for building, implementing, and optimizing content and involves four stages designed to unlock key jobs to be done, and then understanding how to best support facilitators in managing users and using data to iterate content for increased outputs and outcomes.

Impact optimization 720 by the educational growth platform positions each user's contributions as an agile startup, highlighting customer development and leveraging data to optimize designed products and services in ways that allow for design/integration pivots to maximize impact outcomes.

By engaging in an ecological design process in which the to-be-learned content is grounded in goals and user-experiences that users find relevant and useful, as opposed to abstracted content characterizations often arranged in textbooks, the educational growth platform front loads ecosystem integration as it relates to community-valued impact.

After impact optimization, the next step involves translating interview data about occasions where users have made progress, as well as concepts and resources they found useful, into growth activities.

For example, when building a collection designed to support career development, an exemplary ten (10) jobs-to-be-done 725 were created (e.g., failing forward, exploring curiosity, validating moments, personal brand definition, etc.), which were then transformed into growth invitations and application criteria that could be engaged to guide learners in their value-creation moments.

In another example, the following criteria were utilized to frame the value-creation invitation for the “Professional Brand module.” First, good or bad; we all have some kind of reputation already. Reflect on the brand you have been building, even exploring your digital footprint to find and minimize any negative online content and maximize all your good press. Next, articulate what you want your professional brand to be like, and then curate a professional identity and footprint to match (e.g., creating resources like a LinkedIn profile, professional webpage, career-related twitter feed, etc.).

In support of this module, these criteria were then utilized to examine interviewee stories and to imagine the types of value-creation opportunities our future participants might engage.

Next, grow activities were built out including how to cultivate a useful digital footprint, such as, what is brand, and the importance of connecting specifics to one's passions.

There are multiple ways to think about ecosystem integration when one leverages a platform methodology in which the users are both consumers and producers of value. First and foremost is to ensure that when introducing an innovation is that it is done in a manner that is meaningfully integrated into the goals of the learner and the broader ecosystem in which it is being used.

Consider, for example, the ThriveCast methodology as implemented by the educational growth platform and integrated into a classroom learning environment. Successful implementation may require that the educational growth platform becomes an essential tool for both the teacher and students, each of whom view the educational growth platform as useful to achieving goals they value. In the jobs-to-be-done 725 language, the teacher and students should be “hiring” the innovation to achieve goals that they value. While this can be “assigned” by the teacher in some situations, the ultimate goal of an invitational framing is that the student learners or users are themselves engaging authentic motive in terms that are driving participation.

Even in those cases where participation is assigned, the educational growth platform utilizes an integrated user-aware feed which is intended to queue up personally and socially relevant invitations of what the student learner might do next, rather than channeling them through the designer's funnel and forcing a particular path of content consumption.

According to one embodiment, the user-aware feed 730 leverages a know-and-match algorithm that, over time, becomes more effective at connecting people to people and to “modes of experience,” such as connect, grow, share, comment, review, apply, etc., each of which are relevant to the particular student learner in question (see e.g., FIG. 4).

With different ways or modes for the student learner to interact with content via the educational growth platform, student learners are enabled and allowed to engage with available content in ways that they find meaningful to their individual circumstances.

Notably, application stories by student learners detailing their own value creation experiences then create a feedback loop in which such content then serving as core content for the educational growth platform with community feedback and perceived relevance determining what should count for which users.

Thus, while an individual student learner might be a consumer learning from a peer in one moment, they may transition to a mode in which the same student learner is then sharing their experience and insight in the next, switching modes based on their achievement.

Such stories are ecological in the deepest meaning of the word, as they represent local instantiations of the core ideas in that they illuminate a particular application for a particular user. When we review data about which “feed items” serve as the most compelling invitations it is often stories from users who describe their experience rich in detail as opposed to abstract characterizations of how someone might use the content.

In fact, in one implementation of the educational growth platform, it was observed that designer-produced stories containing high-value examples tended to get few user comments, while real user stories that illuminate personal struggle and may be considered as a lesser production quality in terms of expert application, nevertheless received significantly more comments, thus reinforcing the Thrive concept in which each individual learner's experiences and priorities may prove to be more engaging than conventionally produced educational content.

FIG. 7B depicts the partnership process 701 of the educational growth platform, in accordance with described embodiments.

As shown here, the partnership process permits content creators, working in partnership, to understand, design, implement, and optimize member growth and scaled impact. For instance, through the combination of exposing the jobs to be done 725 derived from prior content development 755, a student learner or “player” is then enabled to explore and forge their own journey mapping 760 through the content and user contributions surfaced via the educational growth platform.

FIG. 7C depicts another view of the partnership process 702 of the educational growth platform, in accordance with described embodiments.

As shown here, the partnership process provides ecosystem integration 765 for the educational growth platform, thus exposing student learners to the various modules and community interactions, via the smart feed 766 pushed to the user's GUI displayed to some computing device, be it a mobile device, PC, tablet, or otherwise. As shown here, the user may interact with the comment, connect, share, grow, review, and apply aspects of the educational growth platform seamlessly, intuitively, and without having to follow any pre-specified “pipeline” of interactions which are mandated to the user by previously known techniques.

These interactions then expose the user to impact optimization 770 permitting the user to gain inspiration, learn from others and permit others to learn from the student learner by failing forward, permitting the student learner to build their resume and track their growth and activity, and generally realize success through their self-guided learning journey.

FIG. 7D depicts another view of the partnership process 703 of the educational growth platform, in accordance with described embodiments.

As shown here, the process is designed to ground any development activities that are meaningful to help student learners achieve progress on the goals that they value, with the partnership process including stakeholder alignment 781, journey mapping 782, content development 783, ecosystem integration 784, and research and optimization 785.

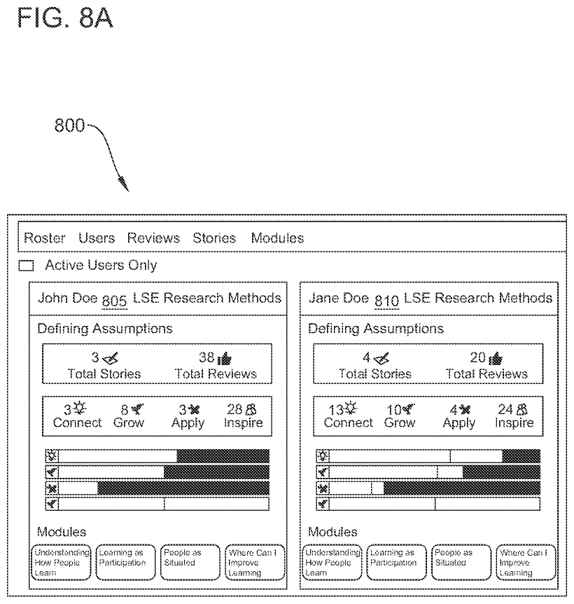

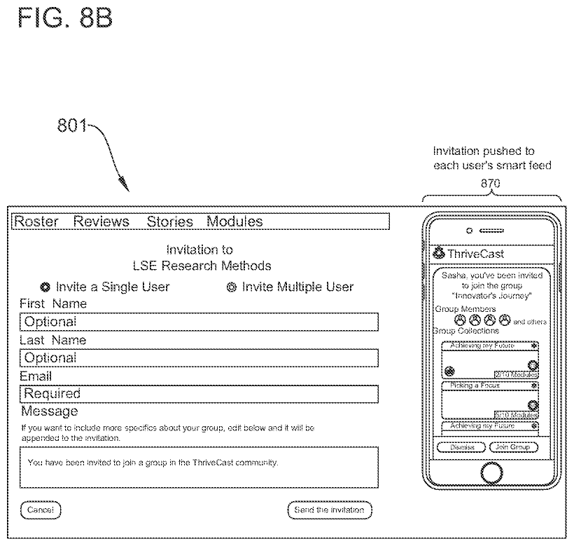

FIG. 8A depicts a facilitator toolkit 800 for managing Micro-Certificate progress within the educational growth platform, in accordance with described embodiments.

As shown here, the facilitator toolkit 800 for managing Micro-Certificates includes the ability to invite users, assign the users to different content, and provide critical feedback to the users to help them succeed.

Certification cards provide facilitators (e.g., professors and staff) overall information about user progress, along with the ability to click on any card component and gather additional data about the student learner's ThriveCast progress, including information about how that particular student has engaged with other users in the group.

For example, exemplary users “John Doe” 805 and “Jane Doe” 810 are shown here, each engaged with LSE research methods. John has 3 stories completed with 38 reviews and Jane has 4 stories completed with 20 reviews. Additionally, progress toward various goals is depicted via the progress bars beneath each of the users, thus providing the facilitator with an intuitive view into progress for each of the depicted users.

FIG. 8B depicts a group invitation tool 801 within the educational growth platform, in accordance with described embodiments.

Through such a tool, the professor may define one or more users to be invited to a particular group, such as an activity group or research group, etc. As shown here, the professor or other administrative level user may define the student participants for the group and a group message, and then push out the message which will then be transmitted to and displayed directly upon the GUI display of all users' mobile computing devices via the mobile app, for instance, by displaying the invitation to the relevant users' smart feed as depicted at element 870.

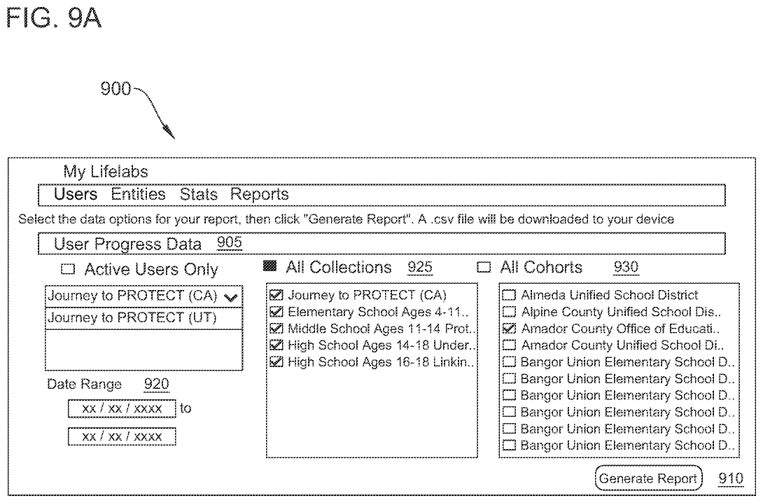

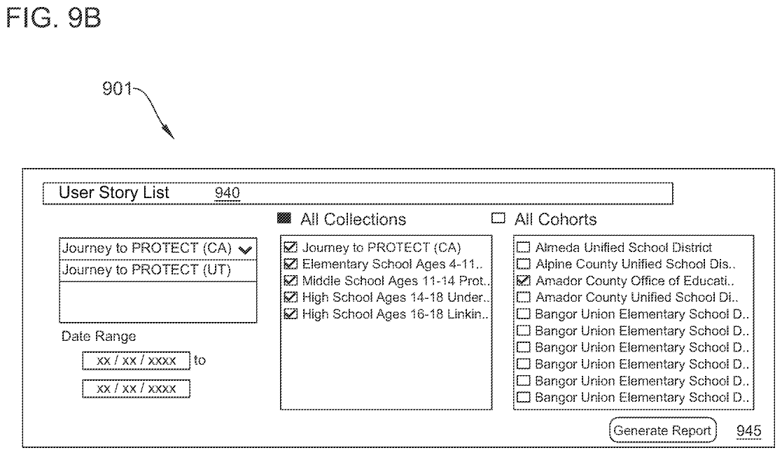

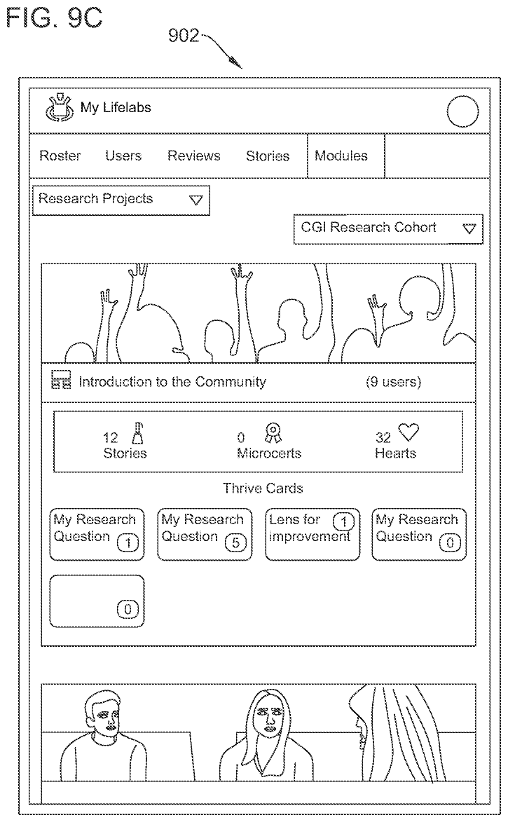

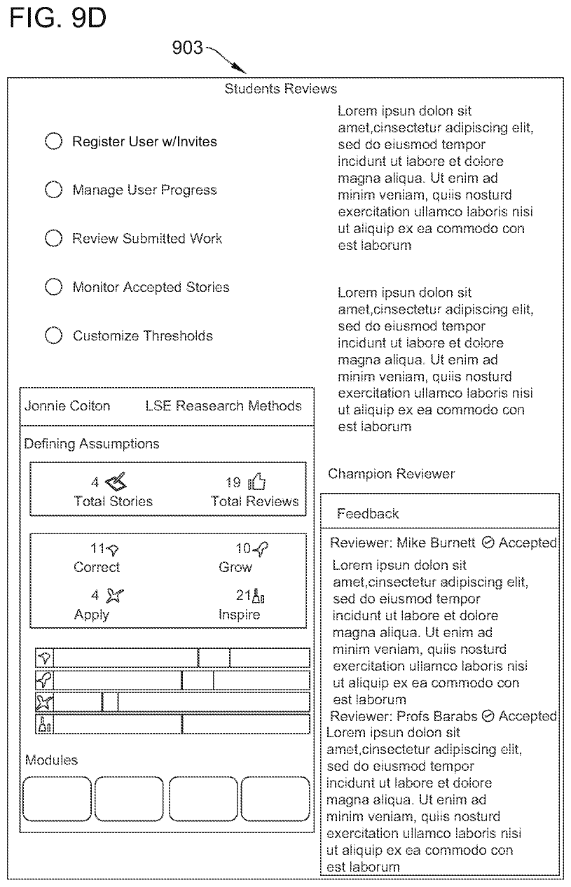

FIG. 9A depicts a manager dashboard 900 for managing groups within the educational growth platform, in accordance with described embodiments.

As shown here, there is a “user progress data” report generator 905 in which the administrator may select the data options for their report and then click “generate” 910 to create a structured “csv” file for download and off-line viewing. For example, the report may be limited by date ranges 920, users, collections 925, cohorts 930, etc.

FIG. 9B depicts another manager dashboard 901 for managing groups within the educational growth platform, in accordance with described embodiments.

Similar to the above described dashboard interface for managing groups, there is depicted here a “user story list” report generator 940 in which the administrator may select the data options for their report and then click “generate” 945 to create a structured “csv” file for download and off-line viewing. For example, the report may be limited by date ranges, users, collections, cohorts, etc.

The manager dashboard provides administrators, teachers, facilitators, professors, etc., with the ability to create new groups and assign particular modules. Additionally, via the manager dashboard 901, administrators may generate reports of interest, showing progress of different groups and members in terms of modules, user-produced stories, and micro-certificates earned.

FIGS. 9C and 9D depict a champion dashboard 902-903 within the educational growth platform, in accordance with described embodiments.

As shown here, the champion dashboard enables a champion to see student reviews, to provide their own reviews, and permits the champion to register users with invites, manage user progress, review submitted work by the users/student learners, monitor accepted stories, and customize thresholds within the educational growth platform.

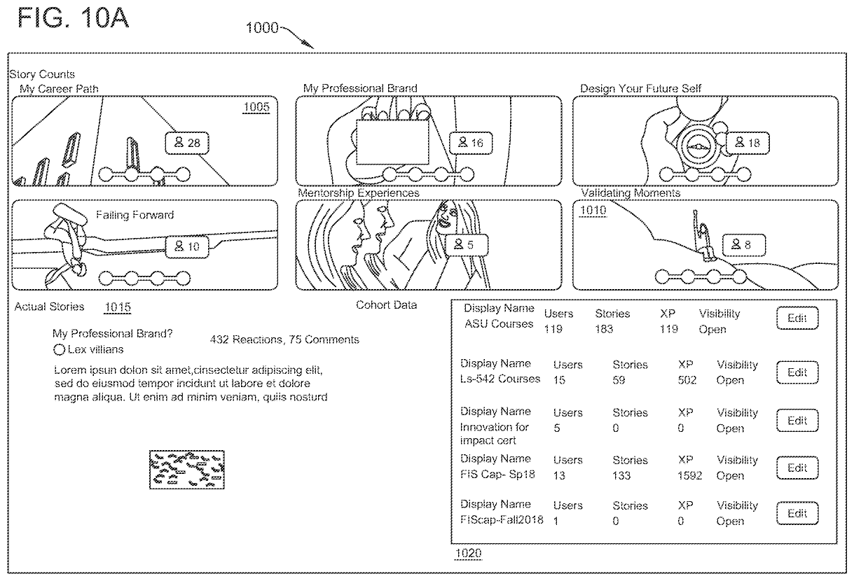

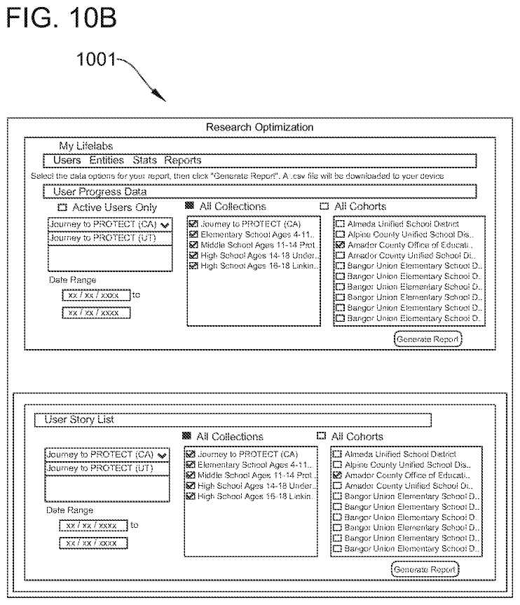

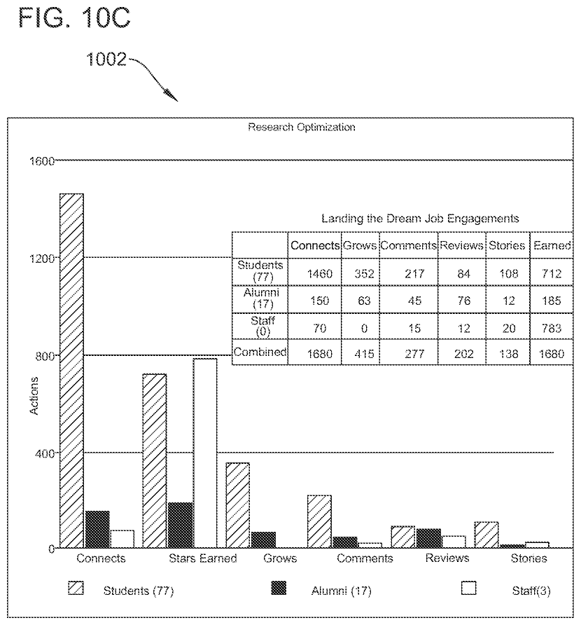

FIG. 10A depicts a research optimization interface 1000 within the educational growth platform, in accordance with described embodiments.

As shown here, teachers, facilitators, and champions may observe story counts, review actual stories, and review cohort data. For instance, the number of student learners with recent activity may be depicted. As shown here, the “my career path” 1005 currently has a 28-person engagement with student learners whereas the “validating moments” 1010 content has only 8 student learners recently engaged with the content.

At the lower left, there are depicted actual stories 1015 which represents user contributed content submitted into the educational growth platform, as opposed to pre-created content. Further still, there are depicted a quantity of user interactions with the user-submitted content, here showing 432 reactions and 75 comments.

At the lower left there is depicted a summary 1020 of university courses, engaged users, published stories, and other statistical dashboard level information for an administrative or manager level user of the educational growth platform.

FIGS. 10B and 10C depict another research optimization interface 1001 and 1002 within the educational growth platform, in accordance with described embodiments.

As shown here, teachers, facilitators, and champions may observe various statistical measurements for their student learners. For instance, there are depicted additional report generators for research optimization reports, user story list reports, as well as graph and tabulated data provided based on student learner engagement with the content of the educational growth platform, such as that depicted at interface 1002.

Thus, disclosed herein is a ThriveCast connected educational growth platform which is focused on supporting growth, impact, and relationship in a manner that powers each persons' ability to thrive. ThriveCast provides an innovative approach to unlocking human potential, powered by platform technologies, informed by the Learning Sciences, and driven by each individual's desire to achieve great things. The process is inspired through peer stories, supported through carefully designed learning challenges and peer mentoring, and culminates in real-world achievements that can be shared back to inspire others.

Integrated within the educational growth platform are Growth and Impact Modules, referring to structured invitations to help members enter a growth opportunity with the ability to thrive in life.

Modules provide key growth interactions for student learners of the educational growth platform, with numerous other features and opportunities designed to support members in creating real-world impact. User-aware feeds are designed to support members in connecting to opportunities that are meaningful to them. Peer and Community interaction is additionally leveraged as a crucial value exchange within the educational growth platform.

Numerous growth journeys have been incorporated into the educational growth platform ranging from Dimensions of Wellness that includes 8 Collections of Growth Modules (Emotional Wellness, Physical Wellness, Financial Wellness, etc.) to STEM Career Pathways that includes 4 Collections of Growth Modules (Discovering Passions, Exploring Professions, Pursuing Pathways, etc.), to the Innovator's Journey with 4 Collections (including, for example, “Me as Innovator,” Designing an Innovation for Impact, Innovation in Society, etc.).

According to certain embodiments, the educational growth platform implements a Teacher Toolkit for registering users and managing progress as well as interfaces permitting student learners to “level up” in a Collection and once they reach “Threshold” such student learners can then submit their community-reviewed work for 1-credit to a university professor.

Through the methodology of Thrive Learning, as enabled via the educational growth platform, users create value, applying what they learn to achieve goals that are important to them using the Thrive Growth Cycle of connect, grow, apply, and inspire. Further still, through connected growth, members may join communities where they share stories about growth, offering comments, support, and inspiration. The custom journeys enable growth opportunities which are easily adapted with layered agency to ensure personal and social relevance, and completed as micro-certifications with target connect, grow, apply, and inspire goals.

According to certain embodiments, the educational growth platform establishes a framework within which everyone is a consumer and producer, with ‘know and match’ algorithms to connect people, ideas, and opportunities.

In such a way, several shortcomings present within the conventional art are overcome. For instance, despite the proliferation of educational software and platforms, education and training has not changed radically in their focus on designing systems to help people consume content, with many such platforms still focusing on a digital delivery of old-school teaching practices. Conversely, the educational growth platform focuses its efforts on how these innovations can unlock latent human potential, with a focus on creating growth, impact and community. At its core, the educational growth platform differs greatly from existing LMSs (Canvas or other online learning systems) in that it is grounded in learning theory principles with infrastructures to motivate and sustain growth over time, while harnessing the latest mobile technologies to support communities of connected learners. The educational growth platform is not about memorization of ideas to apply later, but rather, is focused on supporting any learner in creating immediate value in their world, as part of the learning process, around impact one cares about.

Further still, the educational growth platform is built on the assumption that social interaction catalyzes growth, thus these experiences should involve a community engaged in each other's success, taking on roles of growth and mentoring interchangeably. Designed with a commitment to “mobile first,” the technology is fully responsive and fully operative with any web-supported device and optimized for large-scale deployments, leveraging a thin-and-light API infrastructure making it easy to add additional micro-services or for external integrations.

The educational growth platform which implements the ThriveCast methodologies, while an educational growth platform, starts with what people want to do with that which they are learning in this way inverting the conventional learning flow. Whereas prior learning and growth platforms are focused on consuming value, the ThriveCast model focuses on powering the learner to create value. In this way, expertise and growth is owned by the learner and positioned in the service of their goals. In addition to a focus on value creation, and not content consumption, connecting users are exposed to ever-expanding experiences and to the emerging success of a peer network. Moreover, the educational growth platform is one of the first mobile-first designed platforms, thus permitting it to be fully functional on both mobile solutions as well as desktop solutions, such as conventional PCs.

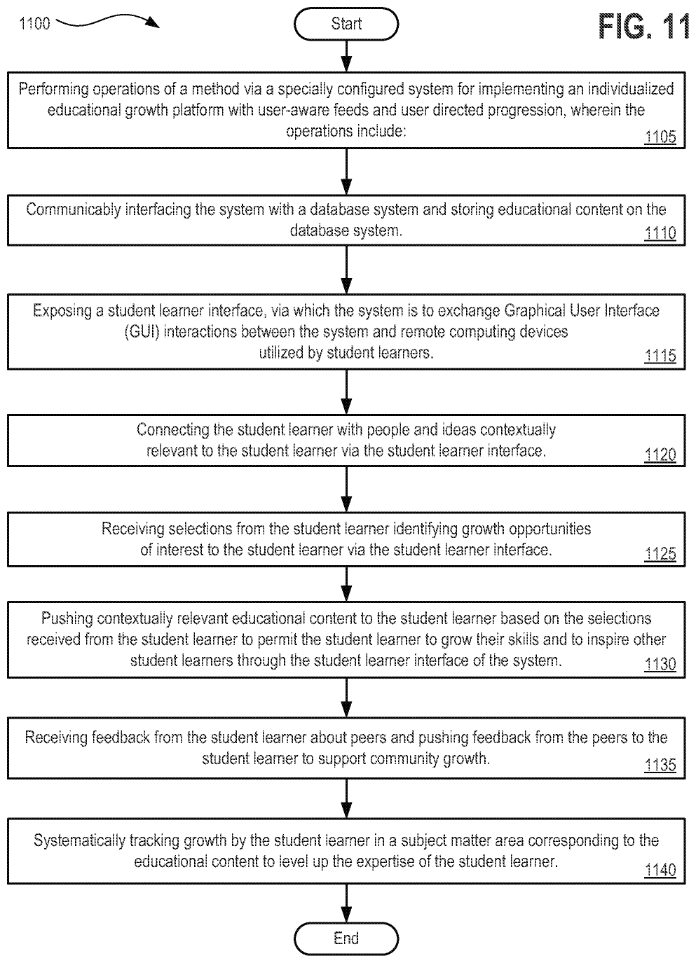

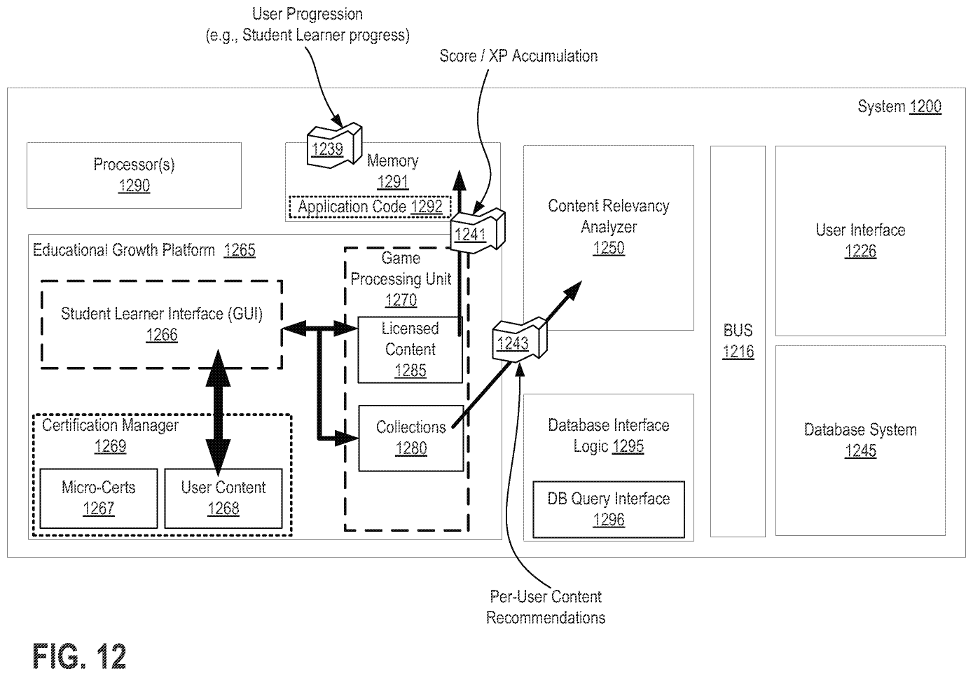

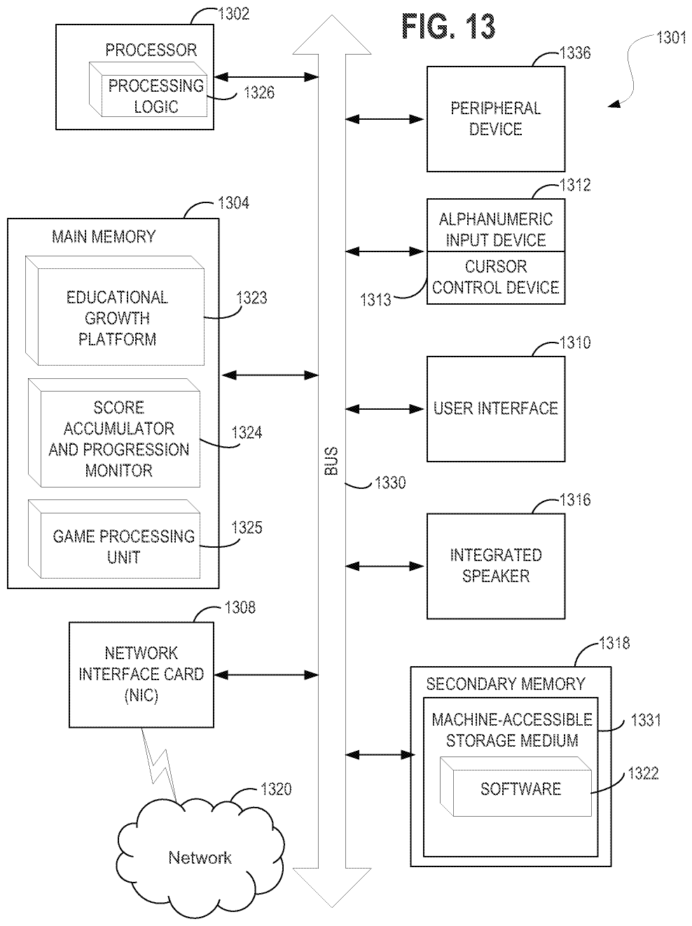

FIG. 11 depicts a flow diagram illustrating a method 1100 for implementing an individualized educational growth platform with user-aware feeds and user directed progression, in accordance with the described embodiments. Method 1100 may be performed by processing logic that may include hardware (e.g., circuitry, dedicated logic, programmable logic, microcode, etc.), software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein. For example, the system 1200 (see FIG. 12) and the machine 1301 (see FIG. 13) and the other supporting systems and components as described herein may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 1100 depicted at FIG. 11, beginning with block 1105, there is a method performed by a specially configured system which executes via a processor and memory of the specially configured system, a method for implementing an individualized educational growth platform with user-aware feeds and user directed progression. Such a system may be configured with at least a processor and a memory to execute specialized instructions which cause the system to perform the following operations:

At block 1110, processing logic communicably interfaces the system with a database system and storing educational content on the database system.

At block 1115, processing logic exposes a student learner interface, via which the system is to exchange Graphical User Interface (GUI) interactions between the system and remote computing devices utilized by student learners.

At block 1120, processing logic connects the student learner with people and ideas contextually relevant to the student learner via the student learner interface.

At block 1125, processing logic receives selections from the student learner identifying growth opportunities of interest to the student learner via the student learner interface.

At block 1130, processing logic pushes contextually relevant educational content to the student learner based on the selections received from the student learner to permit the student learner to grow their skills and to inspire other student learners through the student learner interface of the system.

At block 1135, processing logic receives feedback from the student learner about peers and pushing feedback from the peers to the student learner to support community growth.

At block 1140, processing logic systematically tracks growth by the student learner in a subject matter area corresponding to the educational content to level up the expertise of the student learner.

According to another embodiment of method 1100, such a system embodies an educational growth platform to perform the operations by the student learner interface.

According to another embodiment of method 1100, the system operates as a cloud based on-demand educational growth platform to interact with the student learner via performance of the operations by the student learner interface.

According to another embodiment of method 1100, the educational content stored within the database system includes one or more of: commissioned educational content; licensed educational content; and educational content generated by one or more student learners interacting with the system.

According to another embodiment of method 1100, pushing the contextually relevant educational content to the student learner based on the selections received from the student learner includes: retrieving the contextually relevant educational content from the database system communicably interfaced with the system; and pushing the retrieved contextually relevant educational content to the GUI at the remote device utilized by the student learner via the student learner interface of the system.

According to another embodiment of method 1100, the student learner interface of the system is to perform operations further including: pushing a group page to the GUI at the remote device utilized by the student learner via the student learner interface of the system; and in which the group page is to display to the student learner relevant data and alerts to create gamified feedback for the student learner along with data regarding community interactions.

According to another embodiment of method 1100, systematically tracking growth by the student learner includes implementing a micro-certification framework for user achievement including instituting specific thresholds on module and story counts with threshold scores required to attain a micro-certification.

According to another embodiment of method 1100, threshold scores are based at least on counts of other student learners that have connected or commented on one or more published stories by the student learner.

According to another embodiment of method 1100, the micro-certification is certified by a local group facilitator or an accredited endorsement entity, or both. 1

According to a particular embodiment, there is a non-transitory computer-readable storage medium having instructions stored thereupon that, when executed by a system having at least a processor and a memory therein, the instructions cause the processor of the system to perform operations including: communicably interfacing the system with a database system; storing educational content on the database system; executing the instructions stored within the memory of the system to provide a student learner interface, via which the system is to send and receive Graphical User Interface (GUI) interactions between the system and remote devices utilized by student learners; in which executing the instructions causes the student learner interface of the system to further perform at least the following operations: connecting the student learner with people and ideas contextually relevant to the student learner; receiving selections from the student learner identifying growth opportunities of interest to the student learner; pushing contextually relevant educational content to the student learner based on the selections received from the student learner to permit the student learner to grow their skills and to inspire other student learners through the student learner interface of the system; receiving feedback from the student learner about peers and pushing feedback from the peers to the student learner to support community growth; and systematically tracking growth by the student learner in a subject matter area corresponding to the educational content to level up the expertise of the student learner.

FIG. 12 shows a diagrammatic representation of a system 1200 within which embodiments may operate, be installed, integrated, or configured. In accordance with one embodiment, there is a system 1200 having at least a processor 1290 and a memory 1291 therein to execute implementing application code 1292. Such a system 1200 may communicatively interface with and cooperatively execute with the benefit of remote systems, such as a mobile user device sending instructions and data, a user device to receive a GUI from the system 1200 and to interact with the system 1200 via the student learner interface (GUI) 1266 provided and exposed by the educational growth platform 1265 in support of the described embodiments.

Further depicted within the educational growth platform 1265 and interoperating with the student learner interface (GUI) 1266 are the certification manager 1269 having both the micro-certs 1267 and the user content 1268 as being depicted therein. The student learner interface (GUI) 1266 further interacts with the game processing unit 1270 which further includes the licensed content 1285 and collections 1280. As depicted, user progression 1239 (e.g., progress for each student learner) is stored in the memory 1291 of the system 1200 and the game processing unit 1270 further operates to transmit accumulated scores and XP (e.g., experience points) 1241 from the game processing unit 1270 into memory 1291 where it is then accessible to implementing application code 1292. Still further depicted are the per-user content recommendations 1243 being transmitted from the collections 1280 module of the game processing unit 1270 to the content relevancy analyzer 1250 which operates to identify and surface or otherwise push or expose recommended content to the student learner “players” or users of the educational growth platform 1265 described herein. The database interface logic 1295 in conjunction with the database query interface 1296 serve to communicatively interface the system 1200 with a database system 1245 upon which user and platform content is stored.

According to another embodiment of the system 1200, a user interface 1226 communicably interfaces with a user client device remote from the system and communicatively interfaces with the system via a public Internet and mobile applications may communicate with the system 1200 via the user interface 1226 or via the student learner interface GUI 1266 or other exposed APIs.

Bus 1216 interfaces the various components of the system 1200 amongst each other, with any other peripheral(s) of the system 1200, and with external components such as external network elements, other machines, client devices, cloud computing services, etc. Communications may further include communicating with external devices via a network interface over a LAN, WAN, or the public Internet.

According to a particular embodiment, the system 1200 is further configured to execute instructions via the processor 1290 for implementing an individualized educational growth platform with user-aware feeds and user directed progression, utilizing at least the following components and circuitry of the system 1200. For example, an exemplary system includes the memory 1291 to store instructions; the processor 1290 to execute the instructions stored within the memory 1291; a database system 1245 communicably interfaced with the system to store educational content (e.g., such as licensed content 1285, collections 1280, user content 1268, etc.); and a student learner interface 1266 of the system 1200, via which the system is to send and receive Graphical User Interface (GUI) 1266 interactions between the system and remote devices utilized by student learners. According to such an embodiment, the student learner interface 1266 of the system is to perform at least the following operations: connecting the student learner with people and ideas contextually relevant to the student learner; receiving selections from the student learner identifying growth opportunities of interest to the student learner; pushing contextually relevant educational content to the student learner based on the selections received from the student learner to permit the student learner to grow their skills and to inspire other student learners through the student learner interface of the system; receiving feedback from the student learner about peers and pushing feedback from the peers to the student learner to support community growth; and systematically tracking growth by the student learner in a subject matter area corresponding to the educational content to level up the expertise of the student learner.

FIG. 13 illustrates a diagrammatic representation of a machine 1301 in the exemplary form of a computer system, in accordance with one embodiment, within which a set of instructions, for causing the machine/computer system 1301 to perform any one or more of the methodologies discussed herein, may be executed.

In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1301 includes a processor 1302, a main memory 13011 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1318 (e.g., a persistent storage device including hard disk drives and a persistent database and/or a multi-tenant database implementation), which communicate with each other via a bus 1330. Main memory 1304 includes instructions for executing, exposing, and providing the educational growth platform which is specially configured to expose a student learner interface (GUI) to remotely located user devices. Main memory 1304 further includes the score accumulator and progression monitor 1324 which in collaboration with the game processing unit 1325, tracks user progress, scoring, and experience point (XP) accumulation as the student learners and users interact with the educational growth platform 1323 to level up by consuming educational content and completing specified objectives in furtherance of satisfying requirements to attain a micro-certification as defined by the educational growth platform. Main memory 1304 and its sub-elements are further operable in conjunction with processing logic 1326 and processor 1302 to perform the methodologies discussed herein.

Processor 1302 represents one or more specialized and specifically configured processing devices such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1302 may also be one or more special-purpose processing devices such as an application-specific integrated circuit (ASIC), a field programmable gate array (FPGA), a digital signal processor (DSP), network processor, or the like. Processor 1302 is configured to execute the processing logic 1326 for performing the operations and functionality which is discussed herein.

The computer system 1301 may further include a network interface card 1308. The computer system 1301 also may include a user interface 1310 (such as a video display unit, a liquid crystal display, etc.), an alphanumeric input device 1312 (e.g., a keyboard), a cursor control device 1313 (e.g., a mouse), and a signal generation device 1316 (e.g., an integrated speaker). The computer system 1301 may further include peripheral device 1336 (e.g., wireless or wired communication devices, memory devices, storage devices, audio processing devices, video processing devices, etc.).

The secondary memory 1318 may include a non-transitory machine-readable storage medium or a non-transitory computer readable storage medium or a non-transitory machine-accessible storage medium 1331 on which is stored one or more sets of instructions (e.g., software 1322) embodying any one or more of the methodologies or functions described herein. The software 1322 may also reside, completely or at least partially, within the main memory 13011 and/or within the processor 1302 during execution thereof by the computer system 1301, the main memory 1304 and the processor 1302 also constituting machine-readable storage media. The software 1322 may further be transmitted or received over a network 1320 via the network interface card 1308.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system comprising:
a memory to store instructions;
a processor to execute the instructions stored within the memory;
a database system communicably interfaced with the system to store educational content; and
a student learner interface of the system, via which the system is to send and receive Graphical User Interface (GUI) interactions between the system and remote devices utilized by student learners;
wherein the student learner interface of the system is to perform at least the following operations:
connecting the student learner with people and ideas contextually relevant to the student learner;
receiving selections from the student learner identifying growth opportunities of interest to the student learner;
pushing contextually relevant educational content to the student learner based on the selections received from the student learner to permit the student learner to grow their skills and to inspire other student learners through the student learner interface of the system;
receiving feedback from the student learner about peers and pushing feedback from the peers to the student learner to support community growth; and
systematically tracking growth by the student learner in a subject matter area corresponding to the educational content to level up the expertise of the student learner.

2. The system of claim 1, wherein the system embodies an educational growth platform to perform the operations by the student learner interface.

3. The system of claim 1, wherein the system operates as a cloud based on-demand educational growth platform to interact with the student learner via performance of the operations by the student learner interface.

4. The system of claim 1, wherein the educational content stored within the database system comprises one or more of:
commissioned educational content;
licensed educational content; and
educational content generated by one or more student learners interacting with the system.

5. The system of claim 1, wherein pushing the contextually relevant educational content to the student learner based on the selections received from the student learner comprises:
retrieving the contextually relevant educational content from the database system communicably interfaced with the system; and
pushing the retrieved contextually relevant educational content to the GUI at the remote device utilized by the student learner via the student learner interface of the system.

6. The system of claim 1, wherein the student learner interface of the system is to perform operations further comprising:
pushing a group page to the GUI at the remote device utilized by the student learner via the student learner interface of the system; and
wherein the group page is to display to the student learner relevant data and alerts to create gamified feedback for the student learner along with data regarding community interactions.

7. The system of claim 1, wherein systematically tracking growth by the student learner comprises implementing a micro-certification framework for user achievement including instituting specific thresholds on module and story counts with threshold scores required to attain a micro-certification.

8. The system of claim 7, wherein threshold scores are based at least on counts of other student learners that have connected or commented on one or more published stories by the student learner.

9. The system of claim 7, wherein the micro-certification is certified by a local group facilitator or an accredited endorsement entity, or both.

10. A mobile computing device having functionality configured thereupon to interact with a cloud based on-demand educational growth platform, wherein the mobile device comprises:
a memory to store instructions;
a processor to execute the instructions stored within the memory;
a Graphical User Interface (GUI) to interact with a database system via the cloud based on-demand educational growth platform;
wherein the GUI of the mobile computing device is to perform at least the following operations:
connecting the student learner with people and ideas contextually relevant to the student learner via the cloud based on-demand educational growth platform;
transmit selections to the cloud based on-demand educational growth platform identifying growth opportunities of interest to the student learner;
receive contextually relevant educational content from the cloud based on-demand educational growth platform based on the selections by the student learner at the mobile device permit the student learner to grow their skills and to inspire other student learners through the student learner interface of the system;
transmit feedback from the student learner via the mobile computing device about peers and pushing feedback from the peers to the student learner to support community growth; and
wherein the cloud based on-demand educational growth platform provides systematic tracking growth by the student learner in a subject matter area corresponding to the educational content to level up the expertise of the student learner.

11. The mobile computing device of claim 10:
wherein the mobile computing device interacts with a remotely located system having a processor and memory embodied therein to execute instructions for providing an educational growth platform; and
wherein the educational growth platform is to operate the student learner interface.

12. The mobile computing device of claim 11, wherein the system operates as a cloud based on-demand educational growth platform to interact with the student learner via performance of the operations by the student learner interface.

13. The mobile computing device of claim 10, wherein the educational content stored within the database system comprises one or more of:
commissioned educational content;
licensed educational content; and
educational content generated by one or more student learners interacting with the system.

14. The mobile computing device of claim 10, wherein pushing the contextually relevant educational content to the student learner based on the selections received from the student learner comprises:
retrieving the contextually relevant educational content from the database system communicably interfaced with the system; and
pushing the retrieved contextually relevant educational content to the GUI at the remote device utilized by the student learner via the student learner interface of the system.

15. The mobile computing device of claim 10, wherein the student learner interface of the system is to perform operations further comprising:
pushing a group page to the GUI at the remote device utilized by the student learner via the student learner interface of the system; and
wherein the group page is to display to the student learner relevant data and alerts to create gamified feedback for the student learner along with data regarding community interactions.

16. The mobile computing device of claim 10, wherein systematically tracking growth by the student learner comprises implementing a micro-certification framework for user achievement including instituting specific thresholds on module and story counts with threshold scores required to attain a micro-certification.

17. The mobile computing device of claim 10, wherein the threshold scores are based at least on counts of other student learners that have connected or commented on one or more published stories by the student learner.

18. The mobile computing device of claim 10, wherein the micro-certification is certified by a local group facilitator or an accredited endorsement entity, or both.

19. Non-transitory computer readable storage media having instructions stored thereupon that, when executed by a system having at least a processor and a memory therein, the instructions cause the processor of the system to perform operations including:
communicably interfacing the system with a database system;
storing educational content on the database system;
executing the instructions stored within the memory of the system to provide a student learner interface, via which the system is to send and receive Graphical User Interface (GUI) interactions between the system and remote devices utilized by student learners;
wherein executing the instructions causes the student learner interface of the system to further perform at least the following operations:
connecting the student learner with people and ideas contextually relevant to the student learner;
receiving selections from the student learner identifying growth opportunities of interest to the student learner;
pushing contextually relevant educational content to the student learner based on the selections received from the student learner to permit the student learner to grow their skills and to inspire other student learners through the student learner interface of the system;
receiving feedback from the student learner about peers and pushing feedback from the peers to the student learner to support community growth; and
systematically tracking growth by the student learner in a subject matter area corresponding to the educational content to level up the expertise of the student learner.

20. The non-transitory computer readable storage media of claim 19, wherein systematically tracking growth by the student learner comprises implementing a micro-certification framework for user achievement including instituting specific thresholds on module and story counts with threshold scores required to attain a micro-certification.
